(19) United States
(12) Patent Application Publication
(10) Pub. No.: US 2007/0035542 A1
(43) Pub. Date: Feb. 15, 2007

(54) System, apparatus, and method for capturing and screening visual images for multi-dimensional display

(75) Inventor: Craig Mowry, Southhampton, NY (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Mediapod LLC, Wilmington, DE (US)

(21) Appl. No.: 11/495,933

(22) Filed: Jul. 27, 2006

Related U.S. Application Data
(60) Provisional application No. 60/702,910, filed on Jul. 27, 2005.
(60) Provisional application No. 60/711,345, filed on Aug. 25, 2005.
(60) Provisional application No. 60/710,868, filed on Aug. 25, 2005.
(60) Provisional application No. 60/712,189, filed on Aug. 29, 2005.
(60) Provisional application No. 60/727,538, filed on Oct. 16, 2005.
(60) Provisional application No. 60/732,347, filed on Oct. 31, 2005.
(60) Provisional application No. 60/739,142, filed on Nov. 22, 2005.
(60) Provisional application No. 60/739,881, filed on Nov. 25, 2005.
(60) Provisional application No. 60/750,912, filed on Dec. 15, 2005.

(51) Int. Cl. G06T 17/00

(52) U.S. Cl. 345/420

(57) ABSTRACT

A system, apparatus and method are provided for capturing visual images and spatial data for providing image manipulation options such as for multi-dimensional display.

### CROSS-REFERENCE TO RELATED APPLICATIONS

The present application is based on and claims priority to U.S. Provisional Application Ser. No. 60/702,910, filed on Jul. 27, 2005 and entitled “SYSTEM, METHOD AND APPARATUS FOR CAPTURING AND SCREENING VISUALS FOR MULTI-DIMENSIONAL DISPLAY,” U.S. Provisional Application Ser. No. 60/711,345, filed on Aug. 25, 2005 and entitled “SYSTEM, METHOD APPARATUS FOR CAPTURING AND SCREENING VISUALS FOR MULTI-DIMENSIONAL DISPLAY (ADDITIONAL DISCLOSURE),” U.S. Provisional Application Ser. No. 60/710,868, filed on Aug. 25, 2005 and entitled “A METHOD, SYSTEM AND APPARATUS FOR INCREASING QUALITY OF FILM CAPTURE,” U.S. Provisional Application Ser. No. 60/712,189, filed on Aug. 29, 2005 and entitled “A METHOD, SYSTEM AND APPARATUS FOR INCREASING QUALITY AND EFFICIENCY OF FILM CAPTURE,” U.S. Provisional Application Ser. No. 60/727,538, filed on Oct. 16, 2005 and entitled “A METHOD, SYSTEM AND APPARATUS FOR INCREASING QUALITY OF DIGITAL IMAGE CAPTURE,” U.S. Provisional Application Ser. No. 60/732,347, filed on Oct. 31, 2005 and entitled “A METHOD, SYSTEM AND APPARATUS FOR INCREASING QUALITY AND EFFICIENCY OF FILM CAPTURE WITHOUT CHANGE OF FILM MAGAZINE POSITION,” U.S. Provisional Application Ser. No. 60/739,142, filed on Nov. 22, 2005 and entitled “DUAL FOCUS,” U.S. Provisional Application Ser. No. 60/739,881, filed on Nov. 25, 2005 and entitled “SYSTEM AND METHOD FOR VARIABLE KEY FRAME FILM GATE ASSEMBLAGE WITHIN HYBRID CAMERA ENHANCING RESOLUTION WHILE EXPANDING MEDIA EFFICIENCY,” U.S. Provisional Application Ser. No. 60/750,912, filed on Dec. 15, 2005 and entitled “A METHOD, SYSTEM AND APPARATUS FOR INCREASING QUALITY AND EFFICIENCY OF (DIGITAL) FILM CAPTURE,” the entire contents of which are hereby incorporated by reference. This application is based on and claims priority to, U.S. patent application Ser. No. 11/481,526, filed Jul. 6, 2006, entitled “SYSTEM AND METHOD FOR CAPTURING VISUAL DATA AND NON-VISUAL DATA FOR MULTIDIMENSIONAL IMAGE DISPLAY”, U.S. patent application Ser. No. 11/447,406, entitled “MULTI-DIMENSIONAL IMAGING SYSTEM AND METHOD,” filed on Jun. 5, 2006, the entire contents of which are hereby incorporated by reference.

This application further incorporates by reference in their entirety, U.S. patent Application Ser. No. ______ , filed Jul. 24, 2006, entitled: SYSTEM, APPARATUS, AND METHOD FOR INCREASING MEDIA STORAGE CAPACITY, a U.S. non-provisional application which claims the benefit of U.S. Provisional Application Ser. No. 60/701,424, filed on Jul. 22, 2005; and U.S. Patent Application Ser. No. ______ ,filed Jun. 21, 2006, entitled: A METHOD, SYSTEM AND APPARATUS FOR EXPOSING IMAGES ON BOTH SIDES OF CELLOID OR OTHER PHOTO SENSITVE BEARING MATERIAL, a U.S. non-provisional application which claims the benefit of U.S. Provisional Application Ser. No. 60/692,502, filed Jun. 21, 2005; the entire contents of which are as if set forth herein in their entirety. This application further incorporates by reference in their entirety, U.S. patent application Ser. No. 11/481,526, filed Jul. 6, 2006, entitled “SYSTEM AND METHOD FOR CAPTURING VISUAL DATA AND NON-VISUAL DATA FOR MULTIDIMENSIONAL IMAGE DISPLAY”, U.S. patent application Ser. No. 11/473,570, filed Jun. 22, 2006, entitled “SYSTEM AND METHOD FOR DIGITAL FILM SIMULATION”, U.S. patent application Ser. No. 11/472,728, filed Jun. 21, 2006, entitled “SYSTEM AND METHOD FOR INCREASING EFFICIENCY AND QUALITY FOR EXPOSING IMAGES ON CELLULOID OR OTHER PHOTO SENSITIVE MATERIAL”, U.S. patent application Ser. No. 11/447,406, entitled “MULTI-DIMENSIONAL IMAGING SYSTEM AND METHOD,” filed on Jun. 5, 2006, and U.S. patent application Ser. No. 11/408,389, entitled “SYSTEM AND METHOD TO SIMULATE FILM OR OTHER IMAGING MEDIA” and filed on Apr. 20, 2006, the entire contents of which are as if set forth herein in their entirety.

### FIELD

The present invention relates to imaging and, more particularly, to capturing visuals and spatial data for providing image manipulation options such as for multi-dimensional display. The present invention further relates to a system, apparatus or method for generating light to project a visual image in three dimensions.

### BACKGROUND

As cinema and television technology converge, audio-visual choices, such as display screen size, resolution, and sound, among others, have improved and expanded, as have the viewing options and quality of media, for example, presented by digital video discs, computers and over the internet. Developments in home viewing technology have negatively impacted the value of the cinema (e.g., movie theater) experience, and the difference in display quality between home viewing and cinema viewing has minimized to the point of potentially threatening the cinema screening venue and industry entirely. The home viewer can and will continue to enjoy many of the technological benefits once available only in movie theaters, thereby increasing a need for new and unique experiential impacts exclusively in movie theaters.

When images are captured in a familiar, “two-dimensional” format, such as common in film and digital cameras, the three-dimensional reality of objects in the images is, unfortunately, lost. Without actual image aspects' special data, the human eyes are left to infer the depth relationships of objects within images, including images commonly projected in movie theaters and presented on television, computers and other displays. Visual clues, or “cues,” that are known to viewers, are thus allocated “mentally” to the foreground and background and in relation to each other, at least to the extent that the mind is able to discern. When actual objects are viewed by a person, spatial or depth data are interpreted by the brain as a function of the offset position of two eyes, thereby enabling a person to interpret depth of objects beyond that captured two-dimensionally, for example, in prior art cameras. That which human perception cannot automatically “place,” based on experience and logic, is essentially assigned a depth placement in a general way by the mind of a viewer in order to allow the visual to make “spatial sense” in human perception.

Techniques such as sonar and radar are known that involve sending and receiving signals and/or electronically generated transmissions to measure a spatial relationship of objects. Such technology typically involves calculating the difference in “return time” of the transmissions to an electronic receiver, and thereby providing distance data that represents the distance and/or spatial relationships between objects within a respective measuring area and a unit that is broadcasting the signals or transmissions. Spatial relationship data are provided, for example, by distance sampling and/or other multidimensional data gathering techniques and the data are coupled with visual capture to create three-dimensional models of an area.

Currently, no system or method exists to provide aesthetically superior multi-dimensional visuals that incorporate visual data captured, for example, by a camera, with actual spatial data relevant to aspects of the visual and including subsequent digital delineation between image aspects to present an enhanced, layered display of multiple images and/or image aspects.

### SUMMARY

The present invention relates to imaging and, more particularly, to capturing visuals and spatial data for providing image manipulation options such as for multi-dimensional display, such as a three dimensional display. The present invention further relates to a system, an apparatus or a method for generating light to project a visual image in a three dimensional display. The present invention provides a system or method for providing multi-dimensional visual information by capturing an image with a camera, wherein the image includes visual aspects. Further, spatial data are captured relating to the visual aspects, and image data is captured from the captured image. Finally, the method includes selectively transforming the image data as a function of the spatial data to provide the multi-dimensional visual information, e.g., three dimensional visual information.

A system for capture and modification of a visual image is provided which comprises an image gathering lens and a camera operable to capture the visual image on an image recording medium, a data gathering module operable to collect spatial data relating to at least one visual element within the captured visual image, the data further relating to a spatial relationship of the at least one visual element to at least one selected component of the camera, an encoding element on the image recording medium related to the spatial data for correlating the at least one visual element from the visual image relative to the spatial data, and a computing device operable to alter the at least one visual element according to the spatial data to generate at least one modified visual image. An apparatus is also provided for capture and modification of a visual image.

The encoding element of the system or apparatus includes, but is not limited to, a visual data element, a non-visual data element, or a recordable magnetic material provided as a component of the recording medium. The system can further comprise a display generating light to project a representation of the at least one modified visual image and to produce a final visual image. The final visual image can be projected from at least two distances. The distances can include different distances along a potential viewer's line of sight. The visual image can be modified to create two or more modified visual images to display a final multi-image visual. The image recording medium, includes but is not limited to, photographic film.

A method for modifying a visual image is provided which comprises capturing the visual image through an image gathering lens and a camera onto an image recording medium, collecting spatial data related to at least one visual element within the captured visual image, correlating the at least one visual element relative to the spatial data as referenced within an encoding element on the image recording medium, and altering the at least one visual element according to the spatial data to generate at least one modified visual image.

A system for generating light to project a visual image is provided which comprises a visual display device generating at least two sources of light conveyed toward a potential viewer from at least two distances from the viewer, wherein the distances occur at different depths within the visual display device, relative to the height and width of the device. An apparatus is also provided for generating light to project a visual image. The system can further comprise an image display area of the device occupying a three dimensional zone. In one aspect, aspects of the image occur in at least two different points within the three dimensional zone. The visual display device can further comprise a liquid component manifesting image information as the light. The visual display device can be a monitor, including, but not limited to, a plasma monitor display.

A method for generating a visual image for selective display is provided which comprises generating at least two sources of light from a visual display device, the light being conveyed from at least two distinct depths relative to the height and width of the visual display. In the method, the distinct depths represent distinct points along a potential viewer's line of sight toward the device. The device can display a multi-image visual. The method provided can further comprise displaying the image in an area occupying a three dimensional zone.

Other features and advantages of the present invention will become apparent from the following description of the invention that refers to the accompanying drawings.

### BRIEF DESCRIPTION OF THE DRAWINGS

For the purpose of illustrating the invention, it being understood, that the invention is not limited to the precise arrangements and instrumentalities shown. The features and advantages of the present invention will become apparent from the following description of the invention that refers to the accompanying drawings, in which:

FIG. 1 illustrates a viewer and a screening area from a side view.

FIG. 2 illustrates a theatre example viewed from above.

FIGS. 3A and 3B illustrate a multi-screen display venue in accordance with an embodiment and include a mechanical screen configuration in accordance with one embodiment

FIG. 4 shows a plurality of cameras and depth-related measuring devices that operate on various image aspects.

### DETAILED DESCRIPTION

The present invention relates to imaging and, more particularly, to capturing visuals and spatial data for providing image manipulation options such as for multi-dimensional display. The present invention further relates to a system, apparatus or method for generating light to project a visual image in three dimensions. A system and method is provided that provides spatial data, such as captured by a spatial data sampling device, in addition to a visual scene, referred to herein, generally as a “visual,” that is captured by a camera. A visual as captured by the camera is referred to herein, generally, as an “image.” Visual and spatial data are collectively provided such that data regarding three-dimensional aspects of a visual can be used, for example, during post-production processes. Moreover, imaging options for affecting “two-dimensional” captured images are provided with reference to actual, selected non-image data related to the images; this to enable a multi-dimensional appearance of the images, further providing other image processing options.

In one aspect, a multi-dimensional imaging system is provided that includes a camera and further includes one or more devices operable to send and receive transmissions to measure spatial and depth information. Moreover, a data management module is operable to receive spatial data and to display the distinct images on separate displays.

It is to be understood that this invention is not limited to particular methods, apparatus or systems, which can, of course, vary. It is also to be understood that the terminology used herein is for the purpose of describing particular embodiments only, and is not intended to be limiting. As used in this specification and the appended claims, the singular forms “a”, “an” and “the” include plural references unless the content clearly dictates otherwise. Thus, for example, reference to “a container” includes a combination of two or more containers, and the like.

The term “about” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

Unless defined otherwise, all technical and scientific terms or terms of art used herein have the same meaning as commonly understood by one of ordinary skill in the art to which the invention pertains. Although any methods or materials similar or equivalent to those described herein can be used in the practice of the present invention, the methods or materials are described herein. In describing and claiming the present invention, the following terminology will be used. As used herein, the term, “module” refers, generally, to one or more discrete components that contribute to the effectiveness of the present invention. Modules can operate or, alternatively, depend upon one or more other modules in order to function.

“A data gathering module” refers to a component (in this instance relate to imaging) for receiving information and relaying this information on for subsequent processing and/or recording/storage.

“Image recording medium” refers to the physical (such as photo emulsion) and electronic (such as magnetic tape and computer data storage drives) components of most image capture systems, for example, still or motion film cameras or film or electronic capture still cameras (such as digital.)

“Spatial data” refers to information relating to aspect(s) of proximity of one object relative to another. In this instance a selected part of the camera aspect of the system, and an element (such as an object) within an image being captured in the one configuration by a signal(s) generating device (which transmits a selected signal and times the return of that signal after being deflected back to a receiving and time measuring function of the transmitting device) operating in tandem and/or linked to the camera's operation via reference information tied to both the spatial data and images capture.

“At least one visual element” as with a camera captured visual, whether latent image photo-chemical or electronic capture, there is typically at least one distinct, discernable aspect, be it just sky, a rock, etc. Most images captured have numerous such elements creating distinct image information related to that aspect as a part of the overall image capture and related visual information.

“An encoding element” refers to an added information marker, such as a bar code in the case of visible encoding elements typically scanned to extract their contained information, or an electronically recorded track or file, such as the simultaneously recorded time code data related to video images capture.

“A visual data element” refers to a bar code or otherwise viewable and/or scannable icon, mark and/or impression embodying data typically linking and/or tying together the object on which it occurs with at least one type of external information. Motion picture film often includes a number referenced mark placed by the film manufacturer and/or as a function of the camera, allowing the emulsion itself to provide relevant non-image data that does however relate to the images captured within the same strip of emulsion bearing film stock. The purpose is to link the images with an external aspect, including but no limited to recorded audio, other images and additional image managing options.

“A non visual data element” refers to, unlike bar codes, electronically recorded data conventionally does not change a visible aspect of the media on which it is stored, following the actual recording of data. An electronic reading device, including systems for reading and assembling video and audio data into a viewable and audible result, is an example. In this case, data storage media such as tape and data drives are examples of potential non-visual data elements stored, linking captured spatial data, or other data that is not image data, with corresponding images stored separately or as a distinct aspect of the same data storage media.

“At least one selected component of the camera” refers to an aspect that the spatial data measuring device(s) cannot occupy the exact location as the point of capture of a camera image, such as the plane of photo emulsion being exposed in a film gate, or CCD chip(s.) Thus, there is a selectable offset of space between the exact point of image capture, and/or the lens, and/or other camera parts, one of which will be the spatial point to which the spatial data collected will selectively be adjusted to reference, mathematics providing option(s) to adjust the spatial data based on the selected offset to infer the overall spatial data result, had the spatial data collecting unit occupied the same space as the selected camera “part,” or component.

“At least one modified visual image” refers to modification of a single two-dimension image capture into at least two separate final images, as a function of a computer and specific program referencing spatial data and selective other criteria and parameters, to create at least two distinct data files from the single image. The individual data files each represent a modification of the original, captured image and represent at least on of the modified images.

“Final visual image” refers to distinct, modified versions of a single two-dimensional image capture to provide a selectively layered presentation of images, in part modified based on spatial data gathered during the initial image capture. The final displayed result, to a potential viewer, is a single final visual image the is in fact comprised in one configuration, of at least two distinct two-dimensional images being display selectively in tandem, as a function of the display, to provide a selected effect, such as a multidimensional (including “3D”) impression and representation of the once two-dimensional image capture.

“Final multi-image visual” refers to a single two dimensional image captured is in part broken down into it's image aspects, based on separate data relating to the actual element that occurred in the zone captured within the image. If spatial data is the separate data, relating specifically to depth or distance from the lens and/or actual point or image formation (and /or capture) a specific computer program as a component of the present invention, may in part function to separate aspects of the original image based on selected thresholds determined relative to the spatial data. Thus, at least two distinct images, derived in part from information occurring within the original image capture, are displayed in tandem, at different distances from potential viewer(s) providing a single image impression with a multi-dimensional impression, which is the final multi-image visual displayed.

“Final visual image is projected from at least two distances” refers to achieving one result potential of the present invention, a 3 dimensional recreation of an original scene by way of a two dimensional image modification based on spatial data collected at the time of capture, separate image files created at least breaking the original into “foreground” and “background” data, (not limiting that a version of the full original capture image may selectively occur as one or more of the modified images displayed) with those versions of the originally capture image are projected, and/or relayed, from separate distances to literally mimic the spatial differences of the original image aspects comprising the scene, or visual, captured.

“The distances include different distances along a viewer's line of sight” refers to depth as distance along a viewer's line: Line of sight relative to the present invention, is the measurable distance from a potential viewer(s) eyes and the distances of the entirety of the images along this measurable line. Thus, images displayed at different depth's within a multidimensional display, relative to the display's height and width on the side facing the intended viewer(s) are also occurring at different measurable points if a tape measure were extended from a viewer(s) eyes, through the display, to the two displayed 2 or more displayed 2 dimensional images, the tape measure occurring where the viewer(s) eyes are directed, or his line of sight.

“At least two distinct imaging planes” refers, in one aspect, wherein the present invention displays more than on 2 dimensional image created all or in part from an original 2 dimensional image, wherein other data (in this case spatial data) gathered relating to the image may inform selective modification(s) (in this case digital modifications) to the original image toward a desired aesthetic displayable and/or viewable result.

“Height and width of at least one image manifest by the device” refers to the height and width of an image relative to the height and width of the screening device as the dimensions of the side of the screening device facing and closest to the intended viewer(s).

“Height and width of the device” refers to the dimensions of the side of the screening device facing and closest to the intended viewer(s).

Computer executed instructions (e.g., software) are provided to selectively allocate foreground and background (or other differing image relevant priority) aspects of the scene, and to separate the aspects as distinct image information. Moreover, known methods of spatial data reception are performed to generate a three-dimensional map and generate various three-dimensional aspects of an image.

A first of the plurality of media may be used, for example, film to capture a visual in image(s), and a second of the plurality of media may be, for example, a digital storage device. Non-visual, spatial related data may be stored in and/or transmitted to or from either media, and are used during a process to modify the image(s) by cross-referencing the image(s) stored on one medium (e.g., film) with the spatial data stored on the other medium (e.g., digital storage device).

Computer software is provided to selectively cross-reference the spatial data with respective image(s), and the image(s) can be modified without a need for manual user input or instructions to identify respective portions and spatial information with regard to the visual. Of course, one skilled in the art will recognize that all user input, for example, for making aesthetic adjustments, are not necessarily eliminated. Thus, the software operates substantially automatically. A computer operated “transform” program may operate to modify originally captured image data toward a virtually unlimited number of final, displayable “versions,” as determined by the aesthetic objectives of the user.

In one aspect, a camera coupled with a depth measurement element is provided. The camera may be one of several types, including motion picture, digital, high definition digital cinema camera, television camera, or a film camera. In one aspect, the camera is a “hybrid camera,” such as described and claimed in U.S. patent application Ser. No. 11/447,406, filed on Jun. 5, 2006, and entitled “MULTI-DIMENSIONAL IMAGING SYSTEM AND METHOD.” Such a hybrid camera provides a dual focus capture, for example for dual focus screening. In accordance with one aspect of the present invention, the hybrid camera is provided with a depth measuring element, accordingly. The depth measuring element may provide, for example, sonar, radar or other depth measuring features.

Thus, a hybrid camera is operable to receive both image and spatial relation data of objects occurring within the captured image data. The combination of features enables additional creative options to be provided during post production and/or screening processes. Further, the image data can be provided to audiences in a varied way from conventional cinema projection and/or television displays.

In one aspect, a hybrid camera, such as a digital high definition camera unit is configured to incorporate within the camera's housing a depth measuring transmission and receiving element. Depth-related data are received and selectively logged according to visual data digitally captured by the same camera, thereby selectively providing depth information or distance information from the camera data that are relative to key image zones captured.

In an aspect, depth-related data are recorded on the same tape or storage media that is used to store digital visual data. The data (whether or not recorded on the same media) are time code or otherwise synchronized for a proper reference between the data relative to the corresponding visuals captured and stored, or captured and transmitted, broadcast, or the like. As noted above, the depth-related data may be stored on media other than the specific medium on which visual data are stored. When represented visually in isolation, the spatial data provide a sort of “relief map” of the framed image area. As used herein, the framed image area is referred to, generally, as an image “live area.” This relieve map may then be applied to modify image data at levels that are selectively discreet and specific, such as for a three-dimensional image effect, as intended for eventual display.

Moreover, depth-related data are optionally collected and recorded simultaneously while visual data are captured and stored. Alternatively, depth data may be captured within a close time period to each frame of digital image data, and/or video data are captured. Further, as disclosed in the above-identified provisional and non-provisional pending patent applications to Mowry, incorporated herein by reference in their entirety, that relate to key frame generation of digital or film images to provide enhanced per-image data content affecting for example, resolution, depth data are not necessarily gathered relative to each and every image captured. An image inferring feature for existing images (e.g., for morphing) may allow fewer than 24 frames per second, for example, to be spatially sampled and stored during image capture. A digital inferring feature may further allow periodic spatial captures to affect image zones in a number of images captured between spatial data samplings related to objects within the image relative to the captured lens image. Acceptable spatial data samplings are maintained for the system to achieve an acceptable aesthetic result and effect, while image “zones” or aspects shift between each spatial data sampling. Naturally, in a still camera, or single frame application of the present invention, a single spatial gathering, or “map” is gathered and stored per individual still image captured.

Further, other imaging means and options as disclosed in the above-identified provisional and non-provisional pending patent applications to Mowry, incorporated herein by reference in their entirety, and as otherwise known in the prior art, may be selectively coupled with the spatial data gathering imaging system described herein. For example, differently focused (or otherwise different due to optical or other image altering affect) versions of a lens gathered image are captured that may include collection of spatial data disclosed herein. This may, for example, allow for a more discrete application and use of the distinct versions of the lens visual captured as the two different images. The key frame approach, such as described above, increases image resolution (by allowing key frames very high in image data content, to infuse subsequent images with this data) and may also be coupled with the spatial data gathering aspect herein, thereby creating a unique key frame generating hybrid. In this way, the key frames (which may also be those selectively captured for increasing overall imaging resolution of material, while simultaneously extending the recording time of conventional media, as per Mowry, incorporated herein by reference in their entirety) may further have spatial data related to them saved. The key frames are thus potentially not only for visual data, but key frames for other aspects of data related to the image allowing the key frames to provide image data and information related to other image details; an example of such is image aspect allocation data (with respect to manifestation of such aspects in relation to the viewer's position).

As disclosed in the above-identified provisional and non-provisional pending patent applications to Mowry, incorporated herein by reference in their entirety, post production and/or screening processes are enhanced and improved with additional options as a result of such data that are additional to visual captured by a camera. For example, a dual screen may be provided for displaying differently focused images captured by a single lens. In accordance with an aspect herein, depth-related data are applied selectively to image zones according to a user's desired parameters. The data are applied with selective specificity and/or priority, and may include computing processes with data that are useful in determining and/or deciding which image data is relayed to a respective screen. For example, foreground or background data may be selected to create a viewing experience having a special effect or interest. In accordance with the teachings herein, a three-dimensional visual effect can be provided as a result of image data occurring with a spatial differential, thereby imitating a lifelike spatial differential of foreground and background image data that had occurred during image capture, albeit not necessarily with the same distance between the display screens and the actual foreground and background elements during capture.

User criteria for split screen presentation may naturally be selectable to allow a project, or individual “shot,” or image, to be tailored (for example dimensionally) to achieve desired final image results. The option of a plurality of displays or displaying aspects at varying distances from viewer(s) allows for the potential of very discrete and exacting multidimensional display. Potentially, an image aspect as small or even smaller than a single “pixel” for example, may have its own unique distance with respect to the position of the viewer(s), within a modified display, just as a single actual visual may involve unique distances for up to each and every aspect of what is being seen, for example, relative to the viewer or the live scene, or the camera capturing it.

Depth-related data collected by the depth measuring equipment provided in or with the camera enables special treatment of the overall image data and selected zones therein. For example, replication of the three dimensional visual reality of the objects is enabled as related to the captured image data, such as through the offset screen method disclosed in the provisional and non-provisional patent applications described above, or, alternatively, by other known techniques. The existence of additional data relative to the objects captured visually thus provides a plethora of post production and special treatment options that would be otherwise lost in conventional filming or digital capture, whether for the cinema, television or still photography. Further, different image files created from a single image and transformed in accordance with spatial data may selectively maintain all aspects of the originally captured image in each of the new image files created. Particular modifications are imposed in accordance with the spatial data to achieve the desired screening effect, thereby resulting in different final image files that do not necessarily “drop” image aspects to become mutually distinct.

In yet another configuration of the present invention, secondary (additional) spatial/depth measuring devices may be operable with the camera without physically being part of the camera or even located within the camera's immediate physical vicinity. Multiple transmitting/receiving (or other depth/spatial and/or 3D measuring devices) can be selectively positioned, such as relative to the camera, in order to provide additional location, shape and distance data (and other related positioning and shape data) of the objects within the camera's lens view to enhance the post production options, allowing for data of portions of the objects that are beyond the camera lens view for other effects purposes and digital work.

In an aspect, a plurality of spatial measuring units are positioned selectively relative to the camera lens to provide a distinct and selectively detailed three-dimensional data map of the environment and objects related to what the camera is photographing. The data map is used to modify the images captured by the camera and to selectively create a unique screening experience and visual result that is closer to an actual human experience, or at least a layered multi-dimensional impression beyond provided in two-dimensional cinema. Further, spatial data relating to an image may allow for known imaging options that merely three-dimensional qualities in an image to be “faked” or improvised without even “some” spatial data, or other data beyond image data providing that added dimension of image relevant information. More than one image capturing camera may further be used in collecting information for such a multi-position image and spatial data gathering system.

The examples of specific aspects for carrying out the present invention are offered for illustrative purposes only, and are not intended to limit the scope of the present invention in any way.

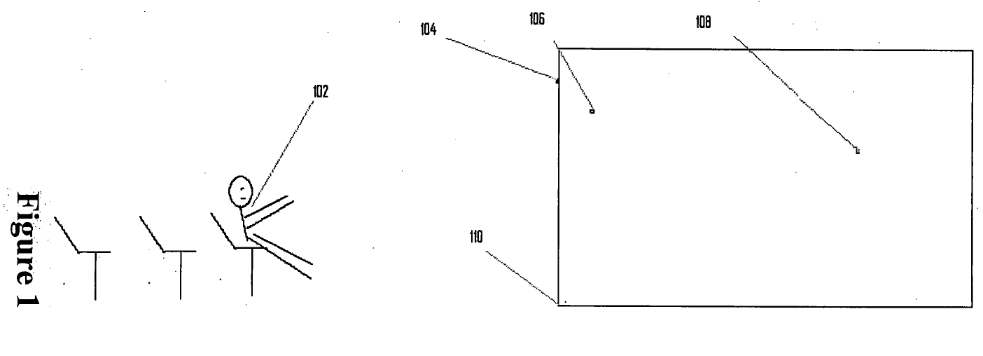

Referring now to the drawing figures, in which like reference numerals refer to like elements, FIG. 1 illustrates cameras 102 that may be formatted, for example, as film cameras or high definition digital cameras, and are coupled with single or multiple spatial data sampling devices 104A and 104B for capturing image and spatial data of an example visual of two objects: a tree and a table. In the example shown in FIG. 1, spatial data sampling devices 104A are coupled to camera 102 and spatial data sampling device 104B is not. Foreground spatial sampling data 106 and background spatial sampling data 110 enable, among other things, potential separation of the table from the tree in the final display, thereby providing each element on screening aspects at differing depth/distances from a viewer along the viewer's line-of sight. Further, background sampling data 110 provide the image data processing basis, or actual “relief map” record of selectively discreet aspects of an image, typically related to discemable objects (e.g., the table and tree shown in FIG. 1) within the image captured. Image high definition recording media 108 may be, for example, film or electronic media, that is selectively synched with and/or recorded in tandem with spatial data provided by spatial data sampling devices 104.

The disclosure related to the capture and recording of both visual and distance information by a camera, digital or film, is further expanded herein. Further, an approach to the invention of dual screen display involving a semi-opaque first screen, (both temporally in one configuration, and physically semi-opaque in other disclosure) is disclosed herein to demonstrate on configuration that is particularly manageable in the current technology.

The present invention provides a digital camera that selectively captures and records depth data (by transmission and analysis of receipt of that transmission selectively from the vantage point of the camera or elsewhere relative to the camera, including scenarios where more than one vantage point for depth are utilized in collecting data) and in one aspect, the camera is digital.

Herein, a film camera (and/or digital capture system or hybrid film and digital system) is coupled with depth data gathering means to allow for selective recording from a selected vantage point(s), such as the camera's lens position or selectively near to that position. this depth information (or data) may pertain to selectively discreet image zones in gathering, or may be selectively broad and deep in the initially collected form to be allocated to selectively every pixel or selectively small image zone, of a selectively discreet display system; for example, a depth data number related to every pixel of a high definition digital image capture and recording means, (such as the SONY CINE ALTA and related cameras.)

Selectively, such depth data may be recorded by “double system” recording, with cross referencing means between the filmed images and depth data provided, (such as with double system sound recording with film) or the actual film negative may bear magnetic or other recording means, (such as a magnetic “sound stripe” or magnetic aspect, such as KODAK, has used to record DATAKODE on film) specifically for the recording of depth data relative to image zones and or aspects.

It is critical to mention, the digital, film or other image capture means coupled with depth sampling and recording means, corresponding to images captured via the image capture means may involve a still digital or film or other still visual capture camera or recording means. This invention pertain as directly to still capture for “photography” as with motion capture for film and/or television and or other motion image display systems.

In the screening phase, digital and/or film projection may be employed, selectively post production means, involving image data from digital capture or film capture, as disclosed herein, may be affected by the depth data, allowing for image zones (or objects and/or aspects) to be “allocated” to a projection means or rendered zone different from other such zones, objects and/or aspects within the capture visuals.

An example, is a primary screen, closer to the audience than another screen, herein called the background screen, the former being referred to as the foreground screen.

The foreground screen may be of a type that is physically (or electronically) transparent, (in part) to allow for manifestation of images on that foreground screen, while also allowing for viewing intermittently of the background screen.

In one potential configuration, which in no way limits the claim herein to all physical, electronic and chemical potential configurations, (or other semi-transparent screen creation means) the screen may be sheath on two rollers, selectively of the normal cinema display screen size(s.)

Herein, this “sheath”, which is the screen, would have selectively large sections and/or strips, which are reflective and others that are not. The goal is to manifest for a portion of time the front projected images, and to allow for a portion of time the audience to “see through” the foreground screen to the background screen, which would have selective image manifestation means, such as rear projection or other familiar image manifestation options not limited to projection (or any kind.).

The image manifesting means may be selectively linked electronically, to allow for images manifested on the foreground screen to be steady and clear, as with a typical intermittent or digital projection experience (film or digital).

The “sheath” described would selectively have means to “move” vertically, or horizontally or otherwise; there purpose being to create a (selectively reflective) projection surface that is solid in part and transparent in part, allowing for a seamless viewing experience of both images on the foreground and background screens by an audience positioned selectively in front of both.

Two screens as described herein is exemplary. It is clearly an aspect of this disclosure and invention that many more screens, allowing for more dimensional aspects to be considered and/or displayed, may be involved in a configuration of the present invention. Further, sophisticated screening means, such as within a solid material or liquid or other image manifesting surface means may allow for virtually unlimited dimensional display, providing for image data to be allocated not only vertically and horizontally, (in a typical two-dimensional display means) but in depth as well, allowing for the third dimension to be selectively discrete in it's display result.

For example, a screen with 100 depth options such as a laser or other external stimuli system wherein zones of a cube” display (“screen”) would allow for image data to be allocated in a discreet simulation of the spatial difference of the actual objects represented within the captured visuals, (regardless of whether capture was film or digital.) Such as “magnetic resonance” imaging, such display systems may have external magnetic or other electronic affecting means to impose a change or “instruction” to (aspects of) such a sophisticated multi-dimensional screening means, (or “cube” screen, though the shape of the screen certainly need not be square or cube like) so that the image manifest is allocated in depth in a simulation of the spatial (or depth) relationship of the image affecting objects as captured (digitally or on film or other image data recording means.)

Laser affecting means manifesting the image may also be an example of external means to affect internal result and thus image rendering by a multidimensional screening means (and/or material) whose components and/or aspects may display selected colors or image aspects at selected points within the multi-dimensional screening area, based on the laser (or other externally, or internally, imposed means.) A series of displays may also be configured in such a multidimensional screen, which allow for viewing through portions of other screens when a selected screen is the target (or selection) for manifesting an image aspect (and/or pixel or the equivalent) based on depth, or “distance” from the viewing audience, or other selected reference point.

The invention herein provides the capture of depth data discreet enough to selectively address (and “feed”) such future display technology with enough “depth” and visual data to provide the multi-dimensional display result that is potentially the cinema experience, in part disclosed herein

The potential proprietary nature of the technology herein, clearly allow for the selection of a capture and screening means to preclude selectively other such capture and screening means, wherein the present invention multi-dimensional capture and display aspects are employed. For example, “film” could be considered one image capture means, but not the only capture means, related to this system.

The present invention also applies to images captured as described herein, as “dualfocus” visuals, allowing for two or more “focusing” priorities of one or more lens image(s) of selectively similar (or identical) scenes for capture. Such recorded captures (still or motion) of a scene, focused differently, may be displayed selectively on different screens for the dimensional effect, herein. Such as foreground and background screens receiving image data relating to the foreground and background focus versions of the same scene and/or lens image.

It is clear that a major advantage to many configurations of the present invention is that image data may be selectively(and purposefully, and/or automatically) allocated to image manifesting means (such as a screen) at a selectable distance from the audience, (rather than only on a screen at a single distance from the viewers). Such an option, with a selectable number of such depth image manifesting options/means, may create a powerful viewing experience closer to “real life” viewing, through two “offset” eyes, which interpret distance and depth (unlike a single lens viewing means.)

Creative options for photograph, film and television (and other display systems) now include the ability to affect image zones and captured “objects” creatively, either in synch with how they were captured or selectively changed for creative effect.

Referring to the drawing figures, in which like reference numerals refer to like elements, FIG. 1 illustrates a viewer 102, and the display of the present invention, 110, from a side view. This configuration demonstrates a screening “area” occupying 3 dimensions, which in this configuration comprises the display itself. Herein, without limiting the other options and internally generated display potential, externally imposed generated influences affect the display aspect themselves, affecting the appearance of “colors” of selected quality and brightness (and color component makeup naturally) which may appear at selectively any point with the three dimensional “display area.”

Pixel 104 occurs on the foreground-most display plane, relative to the viewer. This plane is in essence synonymous with the two dimensional screens of theatres (and most display systems, including computers, televisions, etc.) Herein, pixels 106 and 108 demonstrate the light transmissible quality of the display, allowing these pixels, which are at different points not only relative to height and width (relative to pixel 104) but also in depth. By depth, the reference is to the display's dimension from left to right in the side view of FIG. 1, depth also referring to the distance between nearest possible displayed aspect and farthest, along the viewers line of sight. The number of potential pixel locations and/or imaging planes within the screening area is selectable based on the configuration and desired visual objective.

In an important configuration, the screening area is (for example) a clear (or semi opaque) “cube” wherein, the composition of the cube's interior (substance and/or components) allow for the generation of viewable light occurring at any point within the cube; light of a selectable color and brightness (and other related conventional display options typical to monitors and digital projection.) It is most likely, as a single “visual” captured by a lens as a two dimensional image is being “distributed” through the cube (or otherwise 3 dimensional) display zone, with regards to height and width, there will be in the expected configuration, only one generated image aspect, (such as a pixel though the display light generating or relaying aspect is not limited to pixels as the means to produce viewable image parts) occurring at a single height and width as with 2 dimensional images. However, more than one image aspect may occur at the same depth (or same screening distance relative to the viewer's line of sight) based on the distance of the actual capture objects (for example) within the captured image, objects indeed occurring at the same distance from a camera potentially, when captured by that camera.

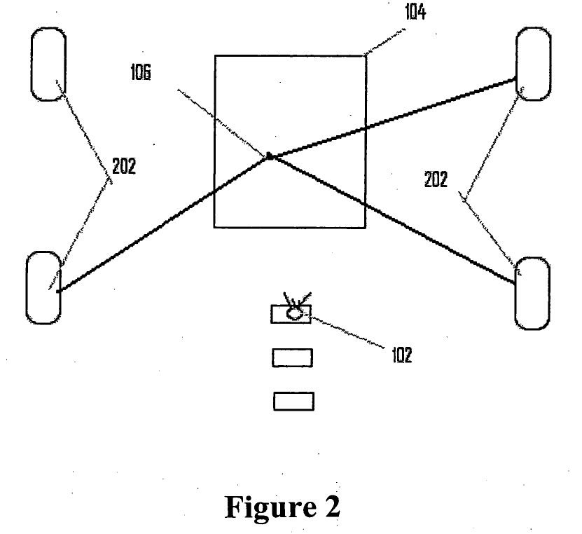

FIG. 2 illustrates the theatre example, from above. Viewer 102 again is seen relative to the 3 dimensional display and/or display area, 104, herein the example of external imaging influences, 202, stimulating aspects, properties and/or components within the display area, (and as a function of the display and external devices functioning in tandem to generate image data within the display area.) This example illustrates components of color being delivered by an array of light transmitting devices, (laser for example being a potential approach and/or influencing affect) herein three such devices demonstrating the creation of viewable light within a very small zone within the cube, (for example an area synonymous with a pixel if not actually a pixel) wherein the three lasers or light providing devices allow a convergence of influences, (such as separate color components intersecting selectively.)

In one configuration, the material properties of the display itself, or parts of the display, would react and/or provide a manifesting means for externally provided light. FIG. 2 demonstrates a single point of light being generated. Naturally, many such points (providing a reproduction of the entire captured visual ideally) would be provided by such an array, involving the necessary speed and coverage of such an externally provided image forming influence (again, in tandem with components, the function of, and/or other properties of the display, or the example “cube” display area.)

Magnetic resonance imaging is an example of an atypical imaging means, (magnetic) allowing for the viewing of cross seconds of a three dimensional object, excluding other parts of the object from this specific display of a “slice.” Herein, a reverse configuration of such an approach, meaning the external (such as the magnet of the MRI) affecting electronically generated imaging affect, herein would similarly (in the externally affected display result) affect selected areas, such as cross sections for example, to the exclusion of other display zone areas, though in a rapidly changing format to allow for the selected number of overall screening distances possible (from the viewer) or in essence, how many slices of the “inverted MRI” will be providable.

Further, as with typical monitors, the selective transparency of the display and means to generate pixels or synonymous distinct color zones, may be provided entirely internally as a function of the display. Changing, shifting or otherwise variable aspects of the display would provide the ability for the viewer to see “deeper” (or farther along his line of sight) into the display at some points relative to others. In essence, providing deeper transparency in parts, potentially as small (or smaller) than conventional pixels, or as large as aesthetically appropriate for the desired display effect.

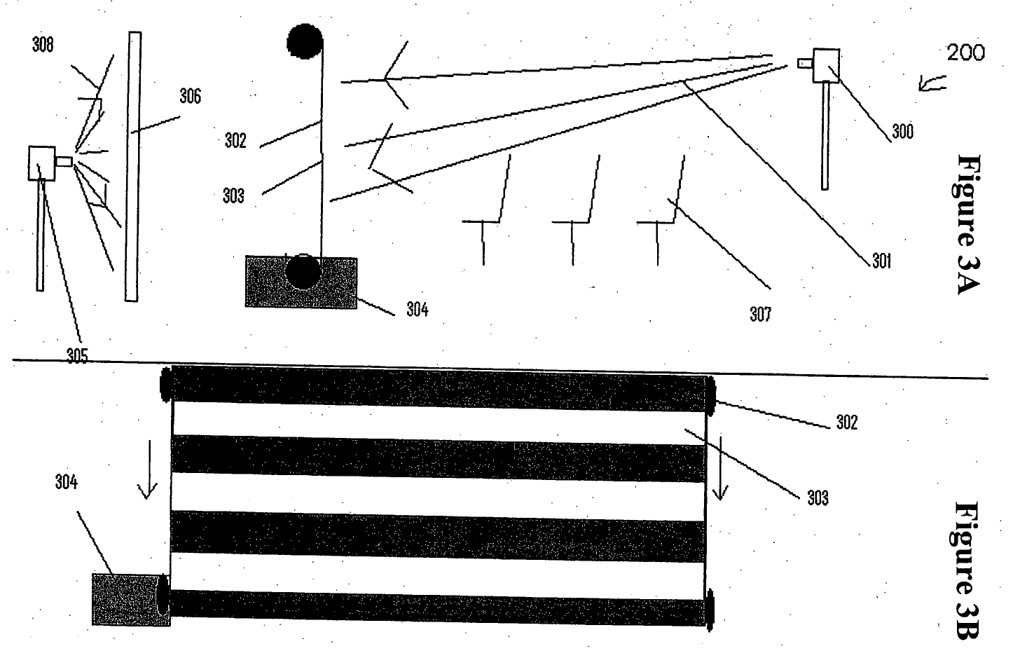

Referring now to FIGS. 3A and 3B, multi-screen display venue is shown, including viewers 307 who view foreground capture version 301, which may be selectively modified a system user. Foreground capture version 301 is provided by data stores, for example, via data manager and synching apparatus. Further, imaging unit 300 projects and/or provides foreground capture version 301 on selectively light transmissible foreground image display, which may be provided as a display screen, includes reflective 303 portions and transparent/light transmissible portions 302, for example, in a mechanical screen configuration shown in FIG. 3B.

In the mechanical screen configuration shown in FIG. 3, a length of moveable screen is transported via roller motor 304. The screen moves selectively fast enough to allow the screen to appear solid, with light transmissible aspects vanishing from portion 302 moving at a fast enough pace, allowing for seamless viewing “through” the clearly visible foreground image information as manifest by (or on) display strips 303, which may be direct view device aspects or image reflective aspects, as appropriate.

The foreground display may be of a non-mechanical nature, including the option of a device with semi-opaque properties, or equipped to provide variable semi-opaque properties. Further, foreground display may be a modified direct view device, which features image information related to foreground focused image data, while maintaining transparency, translucency or light transmissibility for a background display and positioned there behind, selectively continually.

Background display screen 306 features selectively modified image data from background capture version 308, as provided by imaging means 305, which may be a rear projector, direct viewing monitor or other direct viewing device, including a front projector that is selectively the same unit that provides the foreground image data for viewing 300. Background capture version images 308 may be generated selectively continually, or intermittently, as long as the images that are viewable via the light transmissibility quality or intermittent transmissibility mechanics, are provided with sufficient consistency to maintain a continual, seamless background visual to viewers (i.e., by way of human “persistence of vision.”) In this way, viewers vantage point 307 experience a layered, multidimensional effect of multiple points of focus that are literally presented at different distances from them. Therefore, as the human eye is naturally limited to choosing only one “point of focus” at an instance, the constant appearance of multiple focused aspects, or layers, of the same scene, results in a new theatrical aesthetic experience, not found in the prior art.

Although many of the examples described herein refer to theater display, the invention is not so limited. Home display, computer display, computer game and other typical consumer and professional display venues may incorporate a physical separation of layered displays, as taught herein, to accomplish for a similar effect or effects resulting from the availability of the multiple versions of the same lens captured scene. Furthermore, although predominantly foreground focused visuals are generated, such as the conventional two dimensional productions in the prior art, the capture of even one background focused “key frame” per second, for example, is valuable. Such data are not utilized presently for film releases, TV or other available venues. However, various ways to utilize a focused key frame of data for viewing and other data managing options, such as described herein, are not currently manifested.

Thus, the focused second capture version data, even if in an occasional “key frame,” will allow productions to “save” and have available visual information that otherwise is entirely lost, as even post production processes to sharpen images cannot extrapolate much of the visual information captured when focus reveals visual detail.

Thus, a feature provided herein relates to a way to capture valuable data today, and as new innovations for manifesting the key frame data are developed in the future, tomorrow (like the prior art Technicolor movies) users will have information necessary for a project to be compatible, and more interesting, for viewing systems and technological developments of the future that are capable of utilizing the additional visual data.

The present invention is now further described with reference to the following example embodiments and the related discussion.

A multi focus configuration camera, production aspects of images taken thereby, and a screening or post-production aspect of the system, such as multi-screen display venue are included.

Initially, a visual enters the camera, via a single capture lens. A selected lens image diverter, such as prism or mirror devices, fragments the lens image into two selectively equal (or not) portions of the same collected visual, (i.e., light). Thereafter, separate digitizing (camera) units occur, side-by-side, each receiving a selected one of the split lens image.

Prior to the relaying of the light (lens image portions) to the respective digitizers of these camera units, such as CCD, related chips, or other known digitizers, an additional lensing mechanism provides a separate focus ring (shown as focusing optics aspects; See U.S. Ser. No. 11/447,406, filed Jun. 5, 2006, the disclosure of which is incorporated herein by reference in its entirety), for each of the respective lens image portions. The focus ring is unique to each of the two or more image versions and allows for one unit to digitize a version of the lens image selectively focused on foreground elements, and the other selectively focused on background elements.

Each camera is operable to record the digitized images of the same lens image, subjected to different focusing priorities by a secondarily imposed lensing (or other focusing means) aspect. Recording may be onto tape, DVD, or any other known digital or video recording options. The descriptions herein are meant to be limited to digital video for TV or cinema, and, instead, include all aspects of film and still photography collection means. Thus, the “recording media” is not at issue, but rather collection and treatment of the lens image.

Lighting and camera settings provide the latitude to enhance various objectives, including usual means to affect depth-of-field and other photographic aspects.

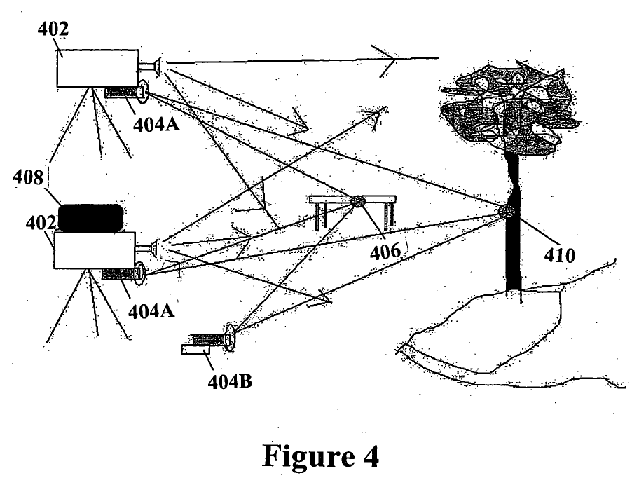

FIG. 4 illustrates cameras 402 that may be formatted, for example, as film cameras or high definition digital cameras, and are coupled with single or multiple spatial data sampling devices 404A and 404B for capturing image and spatial data of an example visual of two objects: a tree and a table. In the example shown in FIG. 4, spatial data sampling devices 404A are coupled to camera 402 and spatial data sampling device 404B is not. Foreground spatial sampling data 406 and background spatial sampling data 410 enable, among other things, potential separation of the table from the tree in the final display, thereby providing each element on screening aspects at differing depth/distances from a viewer along the viewer's line-of sight. Further, background sampling data 410 provide the image data processing basis, or actual “relief map” record of selectively discreet aspects of an image, typically related to discemable objects (e.g., the table and tree shown in FIG. 4) within the image captured. Image high definition recording media 408 may be, for example, film or electronic media, that is selectively synched with and/or recorded in tandem with spatial data provided by spatial data sampling devices 404. See, for example, U.S. patent application Ser. No. 11/481,526, filed on Jul. 6, 2006, and entitled “SYSTEM AND METHOD FOR CAPTURING VISUAL DATA AND NON-VISUAL DATA FRO MULTIDIMENSIONAL IMAGE DISPLAY”, the contents of which are incorporated herein by reference in its entirety.

During colorization of black and white motion pictures, color information typically is added to “key frames” and several frames of uncolored film often has colors that are results of guesswork and often not in any way related to actual color of objects when initially captured on black and white film. The “Technicolor 3 strip” color separating process, captured and stored (within distinct strips of black and white film) a color “information record” for use in recreating displayable versions of the original scene, featuring color “added,” as informed by a representation of actual color present during original photography.

Similarly, in accordance with the teachings herein, spatial information captured during original image capture, may potentially inform (like the Technicolor 3 strip process), a virtually infinite number of “versions” of the original visual captured through the camera lens. For example, as “how much red” is variable in creating prints from a Technicolor 3 strip print, not forgoing that the dress was in fact red and not blue, the present invention allows for such a range of aesthetic options and application in achieving the desired effect (such as three-dimensional visual effect) from the visual and it's corresponding spatial “relief map” record. Thus, for example, spatial data may be gathered with selective detail, meaning “how much spatial data gathered per image” is a variable best informed by the discreteness of the intended display device or anticipated display device(s) of “tomorrow.” Based on the historic effect of originating films with sound, with color or the like, even before it was cost effective to capture and screen such material, the value of such projects for future use, application and system(s) compatibility is known. In this day of imaging progress, the value of gathering dimensional information described herein, even if not applied to a displayed version of the captured images for years, is potentially enormous and thus very relevant now for commercial presenters of imaged projects, including motion pictures, still photography, video gaming, television and other projects involving imaging.

Other uses and products provided by the present invention will be apparent to those skilled in the art. For example, in one aspect, an unlimited number of image manifest areas are represented at different depths along the line of sight of a viewer. For example, a clear cube display that is ten feet deep, provides each “pixel” of an image at a different depth, based on each pixel's spatial and depth position from the camera. In another aspect, a three-dimensional television screen is provided in which pixels are provided horizontally, e.g., left to right, but also near to far (e.g., front to back) selectively, with a “final” background area where perhaps more data appears than at some other depths. In front of the final background, foreground data occupy “sparse” depth areas, perhaps only a few pixels occurring at a specific depth point. Thus, image files may maintain image aspects in selectively varied forms, for example, in one file, the background is provided in a very soft focus (e.g., is imposed).

Although the foregoing invention has been described in some detail by way of illustration and example for purposes of clarity of understanding, it will be readily apparent to one of ordinary skill in the art in light of the teachings of this invention that certain changes and modifications may be made thereto without departing from the spirit or scope of the appended claims.

What is Claimed:

1. A system for capture and modification of a visual image comprising,
an image gathering lens and a camera operable to capture the visual image on an image recording medium,
a data gathering module operable to collect spatial data relating to at least one visual element within the captured visual image, said data further relating to a spatial relationship of the at least one visual element to at least one selected component of the camera,
an encoding element on the image recording medium related to the spatial data for correlating the at least one visual element from the visual image relative to the spatial data, and
a computing device operable to alter the at least one visual element according to the spatial data to generate at least one modified visual image.

2. The system of claim 1 wherein the encoding element is a visual data element.

3. The system of claim 1 wherein the encoding element is a non-visual data element.

4. The system of claim 1 wherein the encoding element is a recordable magnetic material provided as a component of the recording medium.

5. The system of claim 1 further comprising a display generating light to project a representation of the at least one modified visual image and to produce a final visual image.

6. The system of claim 5 wherein the final visual image is projected from at least two distances.

7. The system of claim 6 wherein the distances include different distances along a potential viewer's line of sight.

8. The system of claim 5 wherein the visual image is modified to create two or more modified visual images to display a final multi-image visual.

9. The system of claim 1 wherein the image recording medium is photographic film.

10. The system of claim 5 wherein the final visual image is comprised of at least two distinct imaging planes.

11. A method for modifying a visual image comprising,
capturing the visual image through an image gathering lens and a camera onto an image recording medium,
collecting spatial data related to at least one visual element within the captured visual image,
correlating the at least one visual element relative to the spatial data as referenced within an encoding element on the image recording medium, and
altering the at least one visual element according to the spatial data to generate at least one modified visual image.

12. The method of claim 1 1 further comprising the modification of the at least one visual element with the spatial data by a computing device.

13. The method of claim 11 wherein the encoding element is a data element compatible to be read by at least one scanning device.

14. The method of claim 11 wherein the encoding element is a non-visual data element.

15. The method of claim 11 wherein the encoding element is a recordable magnetic material provided as a component of the recording medium.

16. The method of claim 15 wherein the magnetic material is a magnetic strip of selectable size occurring over the length of the recording medium.

17. The method of claim 15 wherein the recording medium is photographic film stock.

18. The method of claim 15 wherein the magnetic material is a magnetic strip capable of recording any data type storable within a magnetic material, and the magnetic strip capable of providing data.

19. The method of claim 11 further comprising generating light from a display to project a representation of the at least one modified visual image and producing a final visual image.

20. The method of claim 11 further comprising projecting the final visual image from at least two distinct distances from a potential viewer along the viewer's line of sight.

21. The method of claim 11 further comprising combining two or more modified visual images to produce the final visual image.

22. The method of claim 11 wherein the image recording medium is photographic film.

23. The method of claim 19 wherein the final visual image is comprised of at least two distinct imaging planes.

24. An apparatus for capture and modification of a visual image comprising,
an image gathering lens and a camera operable to capture the visual image on an image recording medium,
a data gathering module operable to collect spatial data relating to at least one visual element within the captured visual image, said data further relating to a spatial relationship of the at least one visual element to a selected location,
an encoding element on the image recording medium related to the spatial data for correlating the at least one visual element from the visual image relative to the spatial data, and
a computing device operable to alter the at least one visual element according to the spatial data to generate at least one modified visual image.

25. The apparatus of claim 24 wherein the encoding element is a data element readable by at least one data scanning device.

26. The apparatus of claim 25 wherein the data scanning device is a laser scanning device.

27. The apparatus of claim 25 wherein the data element is a bar code.

28. The apparatus of claim 24 wherein the encoding element is a data element referenced within a data storage medium capable of storing media including video and audio information.

29. The apparatus of claim 28 wherein the data element is a magnetic recordable material.

30. The apparatus of claim 24 further comprising a display generating light to project a representation of the at least one modified visual image and to produce a final visual image.

31. The apparatus of claim 30 wherein generated light related to the final visual image is conveyed from at least two distinct distances to a potential viewer, relative to the viewer's line of sight.

32. A system for generating light to project a visual image comprising,
a visual display device generating at least two sources of light conveyed toward a potential viewer from at least two distances from the viewer, wherein the distances occur at different depths within the visual display device, relative to the height and width of the device.

33. The system of claim 32 further comprising an image display area of the device occupying a three dimensional zone.

34. The system of claim 33 wherein aspects of the image occur in at least two different points within the three dimensional zone.

35. The system of claim 33 wherein the visual display device further comprises a liquid component manifesting image information as the light.

36. The system of claim 33 wherein the visual display device is a monitor.

37. The system of claim 36 wherein the monitor is a plasma monitor display.

38. The system of claim 33 wherein the image display area is selectively transparent, operable to generate light from at least one selectively deep point within the display area, relative to the height and width of at least one two dimensional image generated by the display, said selectively deep point being informed by the spatial data related to aspects of the image as captured.

39. The system of claim 32 wherein the at least two sources of light from the visual display device generate a visible aspect of the final visual image, said final visual image involving at least two distinct points of light generated, wherein the points of light are the smallest visible aspect the visual display is operable to retain with one or more visually recognizable properties.

40. The system of claim 39 wherein the one or more visually recognizable properties is color.

41. The system of claim 39 wherein the visible aspect is displayed at a distance from the viewer, relative to a single line of sight of the viewer, wherein the distance is affected by data collected at the time of initial image capture.

42. The system of claim 33 wherein the visual display device affects at least one selectively sized area of the three dimensional zone.

43. The system of claim 42 further comprising an external component to signal the visual display device within the at least one selectively sized area of the three dimensional zone.

44. The system of claim 43, wherein the external component comprises an electronically generated affect to stimulate at least one aspect of the visual display device.

45. The system of claim 44, wherein the external component comprises at least one light generating device.

46. The system of claim 45, wherein the light generating device is operable to provide light that selectively passes through the at least one selectively sized area of the three dimensional zone.

47. The system of claim 44 wherein the electronically generated affect is magnetic.

48. The system of claim 43 wherein the external component comprises a non-visible transmission affecting the display device.

49. A method for generating a visual image for selective display comprising
generating at least two sources of light from a visual display device, said light being conveyed from at least two distinct depths relative to the height and width of the visual display.

50. The method of claim 49 wherein the distinct depths represent distinct points along a potential viewer's line of sight toward the device.

51. The method of claim 50 wherein the device displays a multi-image visual.

52. The method of claim 49 wherein the method further comprises displaying the image in an area occupying a three dimensional zone.

53. The method of claim 52 wherein the method further comprises displaying aspects of the image in at least two different points within the three dimensional zone.

54. The method of claim 52 wherein the method further comprises manifesting image information as light in a liquid component.

55. The method of claim 52 wherein the visual display device is a monitor.

56. The system of claim 55 wherein the monitor is a plasma monitor display.

57. The method of claim 52 wherein the area occupying the three dimensional zone is selectively transparent, allowing light to be conveyed from at least two depths relative to the height and width of at least one distinct two dimensional image generated within the zone, said depths being affected by non-image data relating to the image as captured.

58. The method of claim 57 wherein the non-image data is spatial data related to aspects of the image as captured.

59. The method of claim 49 wherein the method further comprises generating a visible aspect of the visual image from the at least two sources of light as one or more display points.

60. The method of claim 59 wherein the one or more display points are pixels.

61. An apparatus for generating light to project a visual image comprising,
a visual display device generating at least two sources of light conveyed toward a potential viewer from at least two distances from the viewer, wherein the distances occur at different depths within the visual display device, relative to the height and width of the device.

62. The apparatus of claim 61 further comprising an image display area of the device occupying a three dimensional zone.

63. The apparatus of claim 62 wherein aspects of the image occur in at least two different points within the three dimensional zone.

64. The apparatus of claim 62 wherein the visual display device further comprises a liquid component manifesting image information as the light.

65. The apparatus of claim 62 wherein the visual display device is a monitor.

66. The system of claim 65 wherein the monitor is a plasma monitor display.

67. The apparatus of claim 62 wherein the image display area is selectively transparent, allowing the potential viewer to receive light related to distinct two dimensional images being generated at selectable depths relative to the height and width of at least one of the two dimensional images, the depths being affected by spatial data related to aspects of the image as captured.
